(19) United States
(12) Patent Application Publication
(10) Pub. No.: US 2016/0335933 A1
(43) Pub. Date: Nov. 17, 2016

(54) A SUBMERSIBLE DISPLAY

(71) Applicant: JULIE CLAIRE COMPANY LIMITED, Devon (GB)

(72) Inventors: Julie CLAIRE, Devon (GB); Carole WAITE, Craven Arms, Shropshire (GB)

(73) Assignee: JULIE CLAIRE COMPANY LIMITED, Devon (GB)

(21) Appl. No.: 15/110,165

(22) PCT Filed: Jul. 7, 2014
(86) PCT No.: PCT/GB2014/000271

§ 371 Date: Jul. 7, 2016

(30) Foreign Application Priority Data
Jan. 8, 2014 (GB) 1400308.1

(51) Int. Cl. G09F 13/04; G09F 13/10; G09G 3/30; E04H 4/14; A01K 63/06; G09F 13/22; G09F 13/12

(52) U.S. Cl. CPC G09F 13/0409; G09F 13/22; G09F 13/10; G09F 13/12; E04H 4/148; A01K 63/06; G09G 3/30; G09F 2013/222; G09F 2013/049

(57) ABSTRACT

This invention relates generally to a submersible display in the form of a panel for providing a backlit glazing below a liquid surface. The display has the form of a submersible panel that includes: a light source in the form of a plate having a luminous face that is luminous when lit. Ideally the light source comprises an electro-luminescent sheet for radiating an even light intensity from across a substantially planar face area. Pleasant radiant light and backlit images visible under water are provided by the invention. Preferably the image layer Is a translucent or transparent layer which is backlit by the electro-luminescent sheet light source. Example image layers are thin slices of marble other stone work permit light to penetrate through them.

### FIELD OF THE INVENTION

This invention relates generally to a display and more particularly to a submersible display or decorative fixture in the form of a panel for providing a backlit glazing below a liquid surface.

### BACKGROUND

Lighting displays and light sources are used in everyday situations to improve visibility, to change an ambiance of a room or to serve as a decoration.

Often lighting is provided by fitted ceiling or wall lights or portable lamps. Either of these types of light fixtures may be provided with dimming facility and different colours and furthermore in combination or alone, portability allows greater flexibility in lighting.

Swimming pools, aquariums, and liquid chemical tanks and so forth also need lighting.

### PRIOR ART

U.S. Pat. No. 8,123,381 (Wray) describes an example of submerged lighting devices available in the prior art. The prior art has very limited capability to adjust ambience and illumination in submerged environments. For example U.S. Pat. No. 8,123,381 provides a light emitting diode lighting systems and methods useable to replace incandescent bulbs or other types of light emitting diodes (LED) light sources in enclosed environments, such as in underwater lighting niches used in swimming pool, spa, fountain and other underwater lighting applications.

International publication number WO 00/19869 (Roberts et al) discloses a decorative panel which may be sealed and either evacuated or filled with an inert gas. The decorative panel has an external wall which may be a Fresnel lens, and two transparent walls may be provided, one on each side.

U.S. Pat. No. 7,222,449 (Gourand et al) discloses a picture display that can be adhesively attached to a wall or ceiling, and has a pocket for receiving a flat item.

The prior art does not purport to have invented a luminaire or lighting enhancement and therefore does not aim to change the ambience of a room through illumination,

In contrast the present invention provides a simple means to flexibly and repeatedly allow changes in ambience and illumination in submerged environments.

### SUMMARY OF THE INVENTION

According to a first aspect of the invention there is provided a display comprising: an electro-luminescent sheet light source that radiates light with a substantially uniform intensity, a diffusing layer overlaying the sheet and a window glazing forms an external wall of the display, the glazing is arranged substantially parallel to and face to face with the sheet light sheet so as to define a sandwich assembly whereby the sheet light source is viewable through the glazing.

Ideally the display is incorporated in a submersible decorative fixture in the form of a submersible panel. Preferably the display is a panel suitable for displaying information such as illuminated backlit instructions or maps.

Preferably the display is a decorative fixture for displaying illuminated backlit decorative images such as a marble stone face, painting, drawing, or photograph.

Preferably the sheet light source, the diffusing layer, and the window glazing are arranged sequentially. Preferably the diffusing layer is arranged in front of the sheet light source. Preferably the diffusing layer is arranged face to face with the sheet light source so as to cover the sheet light source. Light radiated from the sheet light source passes through the diffusing layer.

An observer sees sheet light source through the diffusing layer. The diffusing layer evens out variations or ripples of non uniform light intensity radiated from the sheet light source as seen by the observer.

Preferably the window glazing is arranged in front of the diffusing layer. The window glazing thereby forms a fluid proof barrier between a fluid exterior to the display and the diffusing layer and the sheet light source in the interior of the display.

Preferably the display is in the form of a submersible panel and the window glazing forms an exterior face of the panel.

Preferably the submersible panel comprises a fluid proof casing that encases the light source and the diffusing layer. The window glazing forms an external wall of the casing. The window glazing is arranged substantially parallel to and face to face with the sheet face area. Thus the panel is defined by a sandwich assembly with the diffusing layer intermediate the sheet light source and the window glazing.

Ideally the display is incorporated in a submersible decorative fixture in the form of a submersible panel.

Thus use of the present invention under water, and with the light source illuminated, there is provided a planar light source face area radiating an even intensity of light. This provides a pleasant type of illumination that can be used, for example, to illuminate walls or floors of baths, swimming pools, spas and fish tanks in aquaria. Preferably the light intensity is able to be varied by modifying an electric current or voltage supplied to the electro-luminescent sheet light source.

Preferably the diffusing layer and the electro-luminescent sheet may be provided as an integral sheet. The display is therefore simplified by reducing the number of separate parts.

Ideally the integral diffusing layer is a thin flexible sheet and the electro-luminescent sheet is a rigid plate.

Preferably the diffusing layer is etched, frosted or baked, or otherwise adhered on the light source face area. The diffusing layer may be manufactured using processes that are inexpensive and widely available.

Ideally because the display is waterproof it is not subject to degradation when submerged or if it becomes wet.

Preferably the diffusing layer is also etched, frosted, or baked on the window glazing. Hence the display can be simplified and made less expensively as etched and frosted glass are widely available and are cheap.

Preferably the diffusing layer is an opalized sheet or a sheet comprising particles dispersed therewithin so that light passing through the sheet is diffused. Thus the whole thickness of the diffusing layer is effectively employed to diffuse light radiated from the light source face area.

Preferably the first window glazing comprises particles inside it that disperse light passing through the window glazing whereby the diffusing layer and the window glazing are an integral sheet. Thus a separate sheet is not required for the diffusing layer since the diffusing layer and first window glazing are combined.

Preferably the light source face area is in contact and contiguous with the diffusing layer and in turn the diffusing layer is in contact and contiguous with the first window glazing so as form a sandwich assembly without spaces. An advantage with the layers being in contact is the display is a solid and robust structure. It is not possible for fluid to leak between the layers where they are in contact.

A submersible panel is thereby provided in the form of a layered solid. This gives the panel strength to withstand fluid pressure against the window glazing when submerged.

Preferably the sheet face is covered in turn by the diffusing layer, an image layer, and the first window glazing whereby in use light radiates from the light source face area through the image layer to be visible through the first window as a back lit image from the exterior of the casing. Including an image layer to the display enhances the display or decorative fixtures advantageous uses, namely: to make images visible under water such as in swimming pools, baths, and tanks.

Preferably the image layer is defined by a single sheet. Hence the image layer is easily included into the display during assembly. Also the image layer may be printed on the sheet at a specialist studio that prints images and then fitted with a display when it is being assembled.

Preferably the image layer Is a translucent or transparent layer which is backlit by the electro-luminescent sheet light source. Very thin slices of marble other stone work permit light to penetrate through them and are effectively translucent to appear like a glowing stone wall. Paper sheets, transparency films, cutout stencils from paper or film, and glass tiles are also suitable for the image layer. The image layer may be flexible or brittle as it is supported by being face to face with the diffusing layer on one side and the window glazing on the other side.

Different image layers with different images are readily substituted for different customers who wish to customise their display by using their own preferred image in as part of a display.

Preferably the diffusing layer and the image layer are in the form of a single sheet. The number of parts required is thereby reduced, thereby simplifying manufacture and reducing cost.

Advantageously the image layer and the first window glazing are in the form of a single sheet. The image layer is thus easily printed or adhered to the window glazing simplifying manufacture and reducing cost.

Preferably the single sheet is removable from the display by moving the window glazing relative to the electroluminescent sheet. The window glazing may be hinged to the casing or slide in a slot in the casing. By moving the window glazing relative to the electroluminescent sheet access to the interior of the display is obtained. The image layer, diffusion layer, and electroluminescent sheet are sealed inside the casing when display is in use and submerged. Moving the window glazing provides easy access to the interior so that different image layers and diffusion layers can be replaced when desired.

Preferably the light source face area is in contact with the diffusing layer and in turn the diffusing layer is in contact with the image layer and in turn the image layer is in contact with first window glazing so as to form a sandwich assembly without spaces. Thus a solid strong panel is formed to resist fluid pressure.

Preferably the first window glazing and diffusing layer are arranged to define a space intermediate them, said space dimensioned to receive an image layer face to face with the window glazing and diffusing layer whereby with the image layer in the space light radiates from the light source face area through in turn the diffusing layer, the image layer, and the first window glazing whereby in use the image layer is visible through the first window as a back lit image from the exterior of the casing. The space between is ideal for holding replaceable image layers.

Preferably the display comprises a fluid proof air lock in the form of an elongate slot through the casing located parallel and intermediate to the sheet facing and external wall for inserting and removing the image layer into and out of the space. The fluid proof air lock makes it possible to remove and replace an image layer whether it is a single sheet on its own or comprised with the diffusing layer as a single sheet.

Preferably the display comprises a spacer arranged to set a predetermined distance between the window glazing and diffusing layer. The spacer maintains space open even as fluid pressure on submerged fixture presses against the window glazing.

Preferably the electro-luminescent sheet planar face area and diffusing layer are separated by a space layer for enhancing diffusion of light radiating from the planar face area through the diffusing layer. Preferably a spacer arranged to set a predetermined distance between the planar face area and diffusing layer. The distance is thereby maintained by the spacer even against the fluid pressure pressing against the window glazing.

Preferably the display comprises an image layer support fixed to the casing so as to receive and hold an image layer exterior to the casing face to face with the window glazing whereby in use light radiates from the light source face area through the image layer to be visible as a back lit image from the exterior of the casing. Thus the image layer maybe replaced even underwater without opening the casing and exposing the electroluminescent sheet to water.

Preferably the display comprises an image layer support arranged to receive and hold the image layer face to face with the window glazing whereby in use light radiates from the light source face area through the image layer to be visible as a back lit image from the exterior of the casing. Hence the image layer support can also be arranged to hold the image layer inside the casing.

Preferably the image layer support is in the form of a transparent envelope arranged to receive an image layer in the form of a sheet. An envelope is a simple, convenient device, and inexpensive device for holding a sheet. Preferably the envelope comprises a translucent film arranged intermediate the image layer from the light source face area whereby the translucent film of the envelope is the diffusing layer. Thus the envelope has two functions reducing the number of parts required and simplifying the construction of the display.

Preferably the image layer, if present, light source, diffusing layer, first window glazing are transparent providing a transparent view through the display by on-looking through the first window glazing. The utility of the display thereby enhanced since with the light source turned off the display is a transparent panel, or in other words a window.

Preferably the first window glazing is coated with a half-mirror coat whereby light radiated from the planar face area is visible by on-looking at the first window glazing when the light source is on and a reflective mirror is visible on-looking at the first window glazing when the light source is off. The utility of the display thereby enhanced since with the light source turned off the display is effectively panel mirror.

Preferably the decorative panel or display has an electro-luminescent sheet light source that is a two sided sheet radiant from both sides. The light sheet source has a first planar face area on one side and on the opposite side of the sheet a second planar face area for radiating an even light intensity. The second planar area sheet face is covered by a second window glazing forming a second external wall of the casing. The second planar area sheet face is arranged parallel and face to face with the second face area so as to define a sandwich assembly for viewing the face area through the first window and the second face area through the second window. The decorative light source or display is in the form of a panel. A panel may serve as a wall for example separating two swimming lanes in a pool. Thus one decorative fixture or display can form a wall which has evenly radiant surface areas on both sides.

Preferably the second window glazing has a mirrored surface so arranged to reflect light from the second face area back through the electro-luminescent sheet and thence through the first window glazing. This mirror has the effect of almost doubling the amount of light that would be radiated through the first glazing without the mirror.

Preferably the display has a second image layer covering the second face area whereby when the light source is on both image layers are visible from the exterior of the submersible panel as an image backlit by the light source where the second image layer is visible on the opposing side of the submersible panel from which the first image is visible. Thus one decorative fixture can display two different images on the opposite sides.

Preferably the casing of the decorative panel comprises a sash around the perimeter of the panel. Preferably the window glazing elements are sealed by the sash. The seal resists the pressure of the fluid when the decorative panel is submerged. A sash is a simple construction for forming an enclosed case with a window glazing being an external wall.

Preferably the sash covers and seals the perimeter of the first window glazing and/or the second window glazing and the thickness of the glazing is predetermined so that a predetermined deflection of the glazing is caused at predetermined depth of submersion of the display in an exterior fluid so as to reduce glare reflected from the window glazing. Thus the when the light source is turned off the transparent panel of the display is nearly invisible. With the light source turned on the image on the image layer is easily seen though the window glazing.

Preferably the display comprises an aperture providing a passageway through panel for equalizing pressure on both sides of the panel. This is useful for example where the display is mounted underwater where pressure would otherwise build up against one side of the panel.

Preferably there is submersible display in the form of a submersible panel comprises: a fluid proof casing encases a light source comprising an electro-luminescent sheet for radiating an even light intensity from across a substantially planar sheet face area that is covered in turn by a diffusing layer and a first window glazing forming an external wall of the casing arranged substantially parallel to and face to face with the face area so as to define a sandwich assembly whereby the sheet face is viewable through the first window glazing.

According to one aspect of the present invention there is a submersible display in the form of a submersible panel includes: a light source in the form of a plate having a luminous face that is luminous when lit, encased within a fluid-proof/hermetically sealed casing having a first glazing element forming an external wall of the casing that is arranged facing the luminous face to allow light to pass from the luminous face to the exterior of the casing.

A light source in the form of a plate having a luminous face that is luminous when lit, is preferably a light source comprising an electro-luminescent sheet for radiating an even light intensity from across a substantially planar face area when the light source is turned on.

An advantage of the submersible fixture is that it provides a first glazing by which illumination provided under the surface of a liquid by the light source can prearrange the ambiance and intensity experienced by an observer under the surface.

A glazing element is arranged to diffuse light from the light source that passes there through or the display comprises a diffusing filter covering a face of the light source. By diffusing the light from the light source, a diffuse light of even intensity is seen across a face viewable from the exterior of the submersible panel. Preferably the diffusing filter is in the form of sheet that overlays the illuminable plate face.

An advantage of diffusing the light from the light source is that gridwork or light carrying lines on the light source are obscured from the view of an observer exterior to the submersible panel. Another advantage where the diffuse light provides backlight for an image, is that the image is not polluted with gridwork from the light source.

Preferably the display comprises an image layer which in use is backlit by light radiated through it from the illuminable plate face. The image layer may be fixed in front of the external surface of the glazing and therefore outside the fluid proof casing.

An advantage of attaching the image outside the fluid proof casing is that the image layer is easily removed and replaced without the need for unsealing the fluid-proof casing. To protect the image layer from the fluid the submersible display may comprise to receive and support the image layer an envelope made from transparent or translucent material.

The image layer may be fixed behind the internal surface of the glazing and therefore inside the fluid proof casing. An advantage of locating the image layer inside the casing is that the fluid is prevented from wetting the image layer. An image layer that is printed on a medium that would be damaged by the fluid is protected from the fluid.

The image layer and also the glazing is translucent or transparent or comprises a decoration such as a stencil through which light from the light source passes through so as to illuminate the exterior under surface environment and be visible as an image to an observer under the surface. As alternative to a translucent or transparent image, the image layer may be a design feature such as lace where the cutout layers are visible by backlight.

The light source illuminates by passing light through the glazing and the image layer so as to backlight the image layer. The submersible panel may be fixed to form an illuminable floor or wall of a tank, a bath, spa pool, swimming pool, or aquarium.

Advantageously the light source is protected and sealed inside the fluid proof casing from the liquid that is outside the casing when the submersible casing is submerged.

An electrical light source such as light emitting diodes (LEDs) or an electroluminescent sheet is operable inside the fluid-proof casing.

An electrical cord to provide power to the light source is fitted through a fluid-proof sealed opening in the casing.

There may be an external induction coil fitted to an external fixture of the casing and an internal induction coil is fitted to an internal fixture of the casing. The external induction coil is arranged to interact with the internal induction coil so as to transmit electrical power through the fluid-proof casing.

Preferably the display is provided with a control for light source wherein for example brightness may be altered by a dimmer, the light may be coloured, constant or intermittent.

Preferably the casing comprises a second glazing element forming an external wall of the casing that is arranged facing a illuminable plate face to allow light to pass from the illuminable plate face to the exterior of the casing, wherein the first and second glazing are located on opposite sides of light source. Advantageously the submersible panel is able to illuminate the exterior in front and behind it.

Preferably the decorative submersible fixture comprises a second image arranged to be visible from the exterior of the submersible panel as an image backlit by the light source where the second image is visible on the opposing side of the submersible panel from which the first image is visible. Advantageously the first image is visible as a backlit image from the front of the submersible by backlight passing through the first glazing and the second image is visible as a backlit image from the back of the submersible panel by backlight passing through the second glazing.

Preferably glazings and image layers are planar and may be typically square or rectangular, formed from a durable transparent and/or translucent material such as Perspex (Trade Mark), acrylic glass or glass.

In some embodiments at least one of the glazings or image layers may be offset, curved or angled with respect to the light source or surface, wherein the light source may be deflected, diffused or hidden according to such orientation.

In preferred embodiments the casing edges are preferably straight with a rounded or bevelled finish, to avoid sharp edges capable of cutting a person or animal swimming under water if they come into contact with the display.

It may be further envisaged that the display may be used individually or as part of a collection, for example the same image printed in different colours or a whole image may be shown on collections of individual layers or fixtures positioned so that in use a whole image is displayed that is a mosaic of a plurality of submersible displays.

In some embodiments the fixture may be used to represent an underwater window in a swimming pool or aquarium.

The invention will now be described, by way of example only, with reference to the accompanying drawings in which:

### BRIEF DESCRIPTION OF THE FIGURES

FIG. 1 is a perspective view of the display in the form of a submersible panel.

FIG. 2 is a perspective view with a cutaway of the first window glazing to show the interior of the submersible panel illustrated in FIG. 1

FIG. 3 is a side view of an edge of the submersible panel shown in FIG. 1.

FIG. 4 is an isometric view of a corner portion of the submersible panel with light panel switched off.

FIG. 5 is an isometric view of a corner portion of the submersible panel with light source switched on.

FIG. 6 is an isometric view of a corner portion a light source comprising an LED panel switched on with no filters back or front.

FIG. 7 is a view of the face of a light source comprising an LED panel switched on having a filter on the front and back face.

FIG. 8 is a view of a corner portion of the face of a light source comprising an LED panel switched on having a filter on back only.

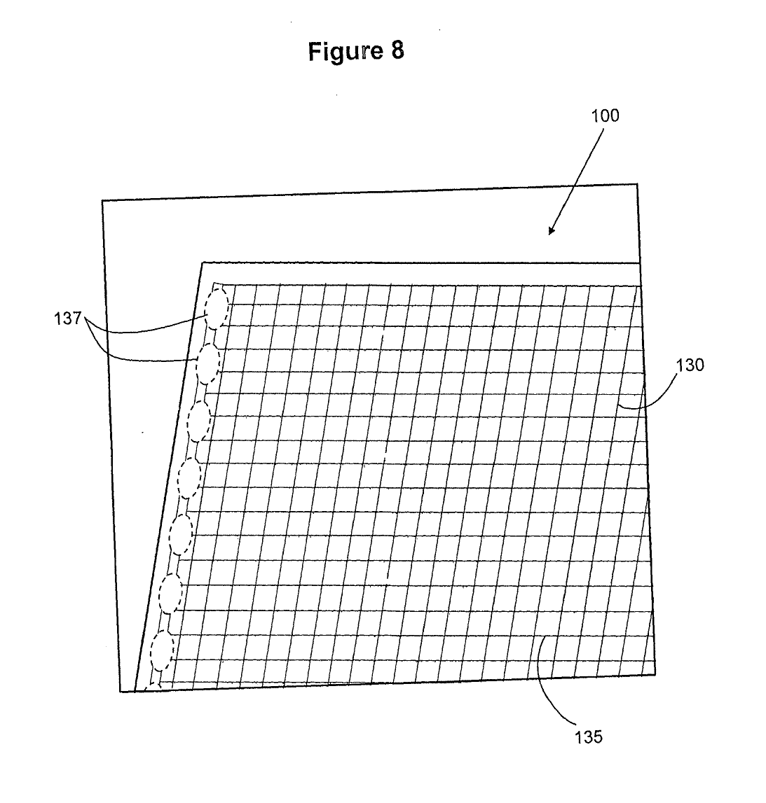

FIG. 9 is a view of a face of a light panel, switched on, having a filter on back and front, and an image layer of waterfall in front.

FIG. 10 is a cross section through the submersible panel showing cross section through the side edge where there are without spacers between layer.

FIG. 11 is a perspective view of an example of the decorative panel as a solid panel without space between the layers.

FIG. 12 is a perspective view of the display in the form of a submersible panel where the light source sheet is encased within a casing around the perimeter.

### DETAILED DESCRIPTION OF PREFERRED EMBODIMENTS OF THE INVENTION

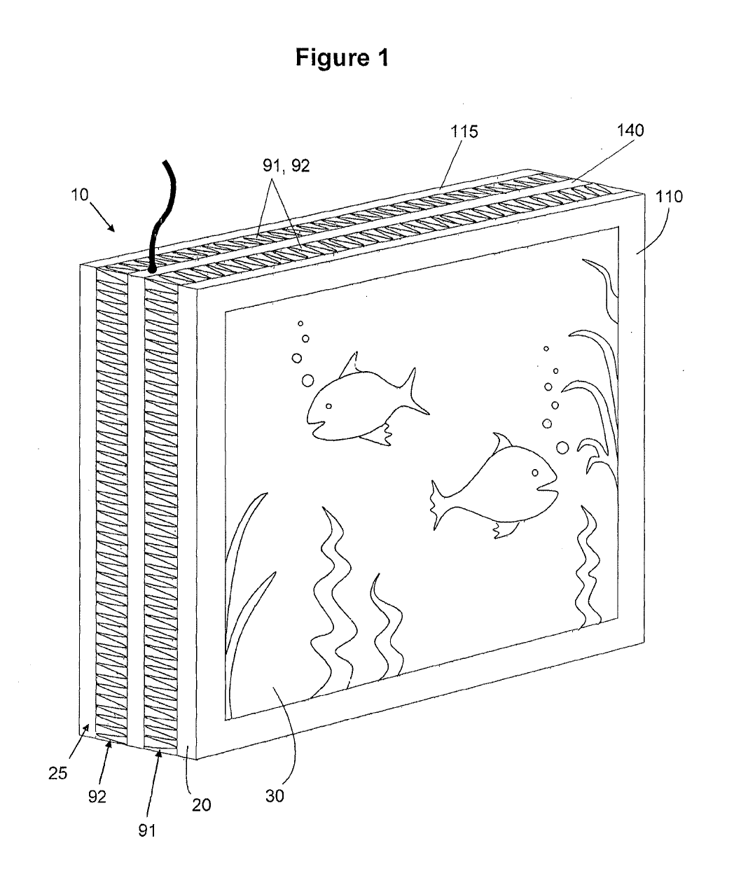

There is shown in FIG. 1 a decorative fixture or display 10 in the form of a submersible panel. The submersible panel has a plate-like form.

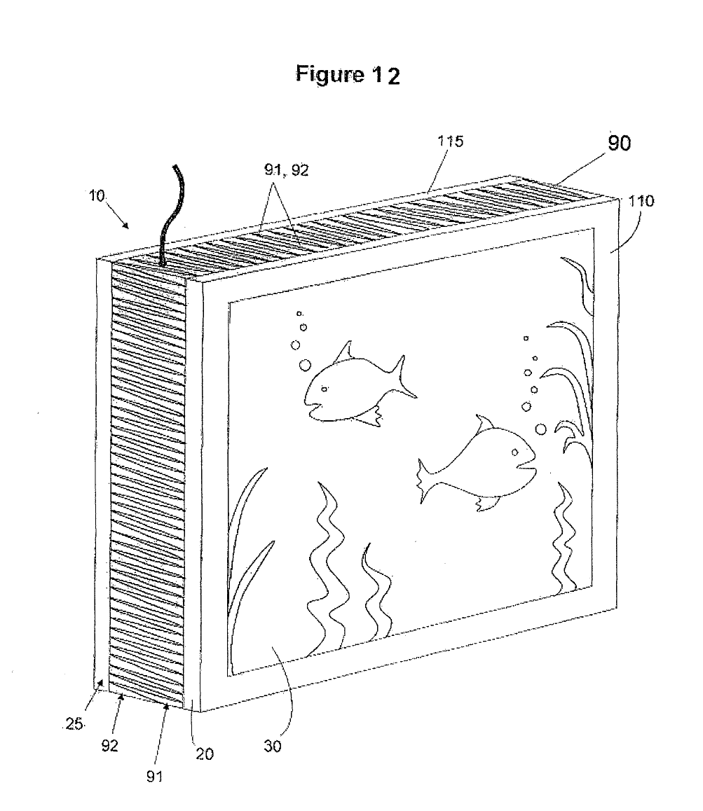

FIG. 12 shows another example of the decorative fixture or display. The length and width of the electro-luminescent light source sheet 140 is less than the length and width of the window glazings 110 and 115. A casing comprises a seal 90 that is fluid proof and surrounds the perimeter of the electro-luminescent light source sheet. Thus In the example of FIG. 12 the seal 90 covers the perimeter edge of light source sheet so that in the example of FIG. 12 that light source sheet cannot be seen.

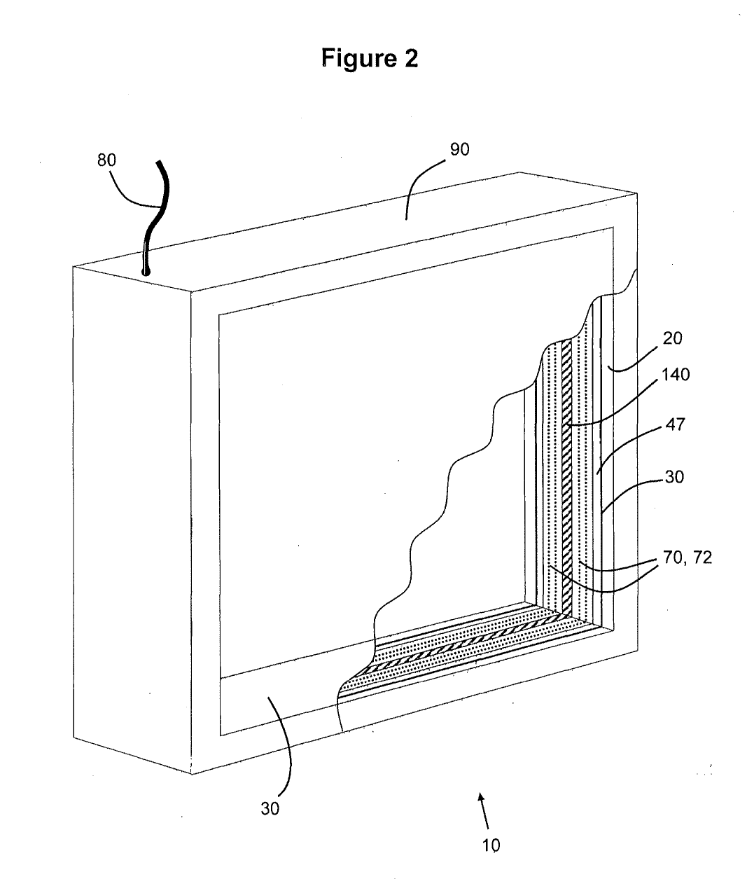

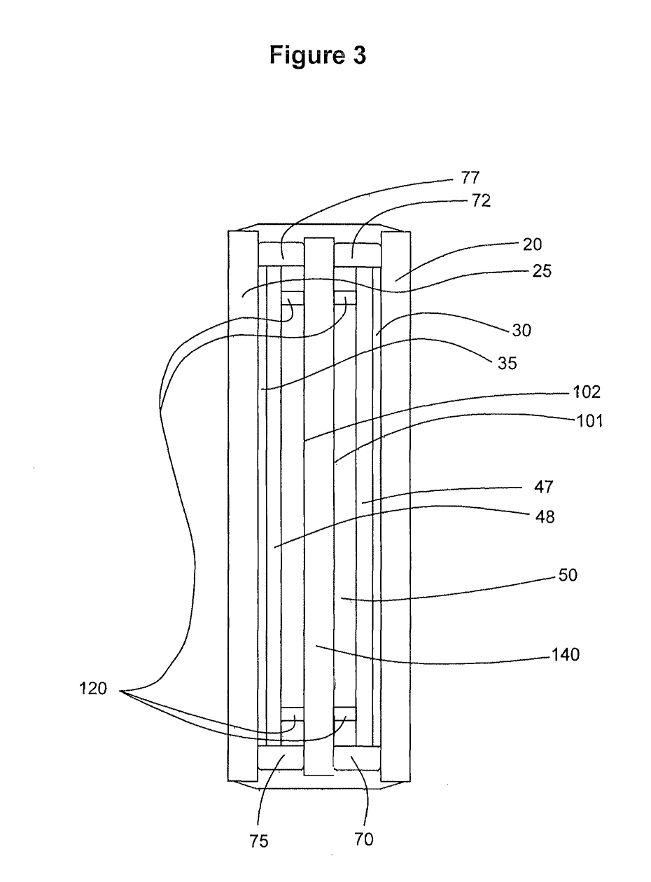

The submersible panel comprises a light source 100 encased within a fluid-proof casing 20, 25, 90 having a first window glazing 20 arranged to pass light from the light source 100 to the exterior of the casing. As shown in the cutaway view of FIG. 2 and the edge view of FIG. 3 the light source comprises a polymer or glass sheet 140 with a substantially planar face area. A gentle curve of the sheet light source is possible. A glazing is pane or sheet of glass or polymeric material set or made to be set as window in frame or a sash of the casing.

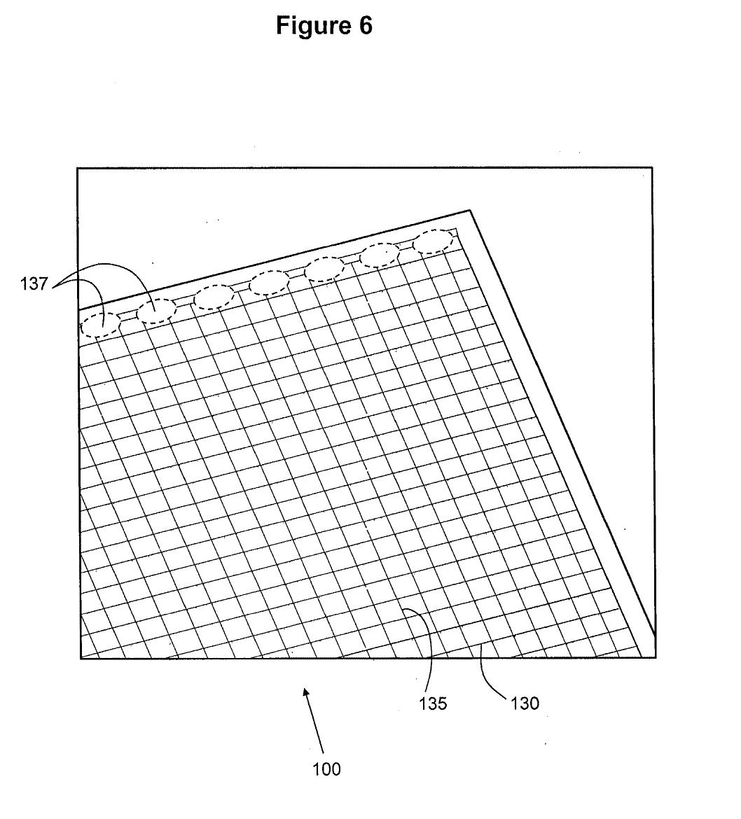

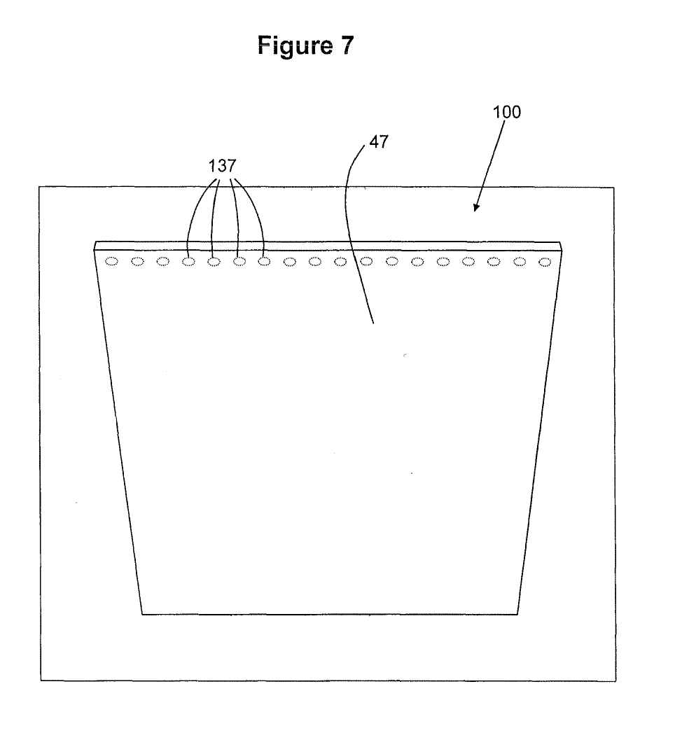

The light source is shown separately in FIGS. 6 and 7. The light source has the form of a plate having two parallel faces 101, 102 on the front and back. At least one of the parallel faces is luminous when the light source is lit. An illuminable plate face that is luminous when lit is arranged to shine light at the first glazing 20. The light shines through the first glazing 20 to the exterior of the casing. As shown in cutaway view FIG. 2, the light source 100 has an illuminable plate face that is arranged facing the first glazing.

A face of the light source 100 that is luminous when lit is herein referred to as an illuminable plate face.

The first glazing 20 is an external wall of the casing. The first glazing is a window pane which is transparent or translucent. Light from the light source 100 passes through the window pane and illuminates the exterior region in front of the window pane.

An advantage of the submersible panel is that it is arranged to operate underneath the surface of a fluid. The exterior region underneath the surface of the fluid is illuminated by the submersible decorative fixture in use.

The light source 100 has a perimeter 103 the edge of the face 101, 102 as shown in FIG. 7.

Various constructions of the light source are possible. One construction of the light source 100 comprises a face comprising numerous point devices of light distributed across the face. The point sources of light may be LEDs, incandescent bulbs or another point source type of light.

The point devices of light may be microscopic or near microscopic and arranged so closely together that when they are activated the face appears to radiate light from the surface when lit. Thus the entire illuminable plate face appears luminous when activated. It has the effect of shining through and backlighting the entire glazing with a luminous light.

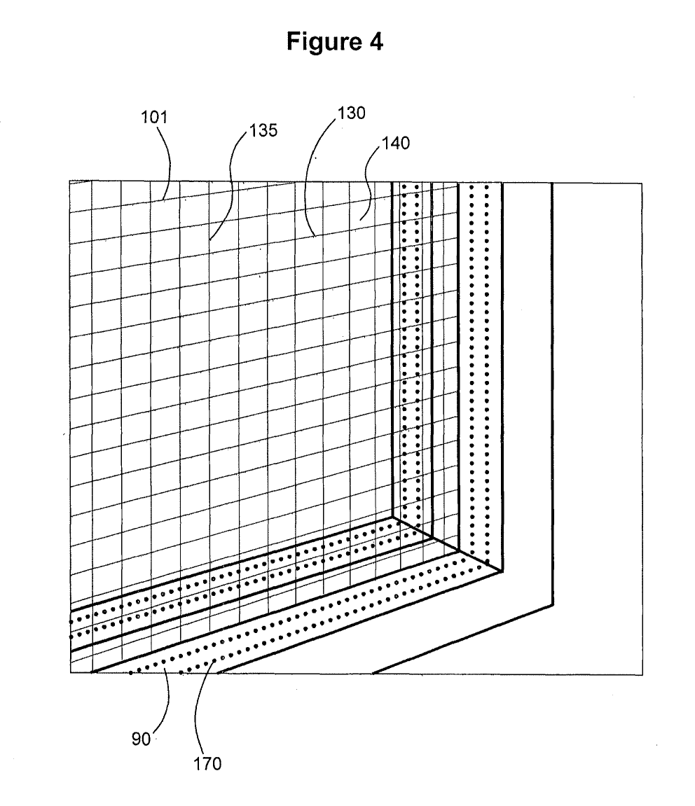

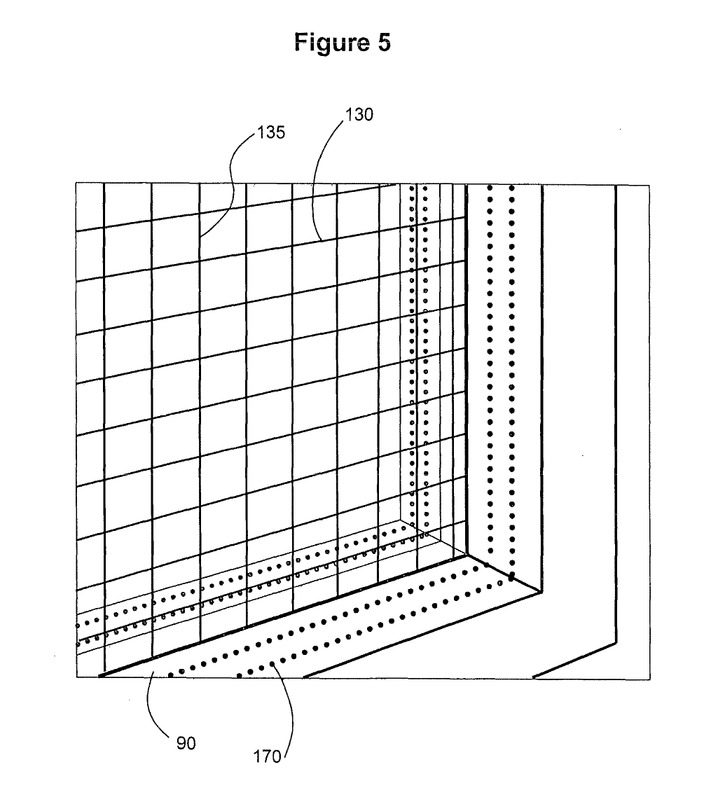

An alternative construction of the light source 100 is shown in FIG. 6. The light source comprises a polymer or glass sheet 140. It is a rigid pane referred to as ns an electro-luminescent sheet light source. The sheet 140 may be an acrylic sheet, or a polycarbonate sheet, or a polypropylene sheet or glass or another material that is transparent or translucent. The sheet 140 comprises light lines 130, 135 cut into the planar face area or tubular openings parallel to the substantially planar face area of the sheet. The light lines 130, 135 are shown in FIGS. 4, 5, and 6. The light lines emanate from the perimeter of the sheet 140 forming a gridwork pattern visible through the faces 101, 102 in the sheet 140.

Point devices of light 137 are located around the perimeter of the sheet 140. Light from these point devices is carried by the lines 130, 135 across the gridwork pattern in the face of the sheet 140. The gridwork 130, 135 carries light from the point devices of light 137 on the perimeter of the sheet and illuminates both faces, front and back, of the sheet. Thus the gridwork pattern and therefore the faces 101, 102 of the front and back of the sheet 140 appear luminous when the point devices of light 137 around the perimeter of the sheet 140 are activated.

Another construction of the light source 100 is a panel in the form of a plate that houses discrete light bulbs and possibly mirrors and is covered by a frosted windows. The plate that houses the items is also constructed to be fluid-proof, and preferably the panel is constructed to be waterproof to an IP67 or ip68 rating. The arrangement of the bulbs is such that light from the light source radiates toward the first glazing 20.

IP (or “Ingress Protection”) ratings are defined in international standard EN 60529 (British BS EN 60529:1992, European IEC 60509:1989). They are used to define levels of sealing effectiveness of electrical enclosures against intrusion from foreign bodies (tools, dirt etc) and moisture. An ip68 rating is a higher rating than ip67, and a submersible decorative fixture or display that is ip68 rated is suitable for safe use as an electrical appliance underwater where swimmers or bathers are also present in the water.

A secondary waterproof sheath may be constructed to an IP67 or ip68 waterproof standard and enclose the light source 100. The waterproof case provides an additional barrier to the fluid that is exterior to the submersible decorative fixture.

As shown in FIGS. 1, 2, 3, 4, and 5 the light source 100 is encased within the fluid-proof casing 20, 25, 90 having a first glazing 20 and second glazing 25 arranged to pass light from the light source 100 to the exterior of the casing.

FIG. 3 shows the decorative panel is arranged with a first glazing 20 and a second glazing 25 on both sides of the decorative panel. The second glazing comprises an external wall of the casing.

FIG. 3 shows the side view of an edge of a submersible panel having a light source 100 in the form of a plate. The plate 100 is in the middle of the submersible panel. The light source is arranged face to face with the first glazing and the first glazing is arranged face to face with a second glazing 25. The plate 100 is an electroluminescent sheet in the form of an illuminable plate.

The second glazing may be a second window pane. Light from the light source 100 passes through the second window pane and illuminates the exterior region in front of the second window pane which is the exterior region behind the submersible display or decorative fixture.

A submersible display comprising both a first glazing and a second glazing is arranged to illuminate the exterior region below the surface of the fluid in front of the submersible decorative unit and behind the submersible fixture.

The light that illuminates the face of the polymer or glass sheet 140 is radiated from the face of the sheet toward the first and second glazing. The radiated light passes through the first and second glazing 20, 25. When lit the faces 101, 102 of the sheet 140 illuminate the exterior of the submersible decorative panel. The light which radiates outwards from the light panel can radiate from one or both faces 101, 102 of the panel enabling both of the outer faces, front and back of the submersible panel to be illuminated if required. A single light source 100 can radiate light out through the first glazing 20 to the front exterior of the submersible panel and out the second glazing 25 to the back exterior of the submersible panel.

Because the casing which has walls formed by the first glazing 20, and the second glazing 25 are transparent, and because the light source 100 is transparent, a viewer external to the submersible panel can see though the illuminable plate faces 101, 102 of the glazings and the polymer or glass sheet 140 and so see through the submersible panel. The viewer external to the submersible panel can see through the panel from the exterior region in front of the submersible panel to the exterior region behind the panel. Since the light source and casing are transparent there is a view through the submersible panel and illuminable plate face.

As shown in the cut-away view FIG. 2, the casing comprises a sash 90 which covers the perimeter edge of the first glazing 20, the second glazing 25 and the light source 100. The perimeter of the glazing 20, 25 is sealed to the sash 90 with a fluid-proof seal so as to form the fluid-proof casing. The light source 100 is fixed to an internal surface or component of the casing.

The seal 91, 92 itself may form the sash 90. The sash 90 may be formed of sealant which itself comprises the sash. Thus rather than there being a separate layer of sash and sealant, it is all one layer. There may also be an extra sash layer.

The fluid-proof seal may be a caulking adhesive that permanently fixes the glazing to the sash. The fluid-proof seal may be a gasket arranged between the glazing 20, 25 and sash 100. An elastomer gasket is re-usable if the glazing is removed from the sash so as to gain access to the interior of the casing 20, 25, 90 if for instance the light source 100 or an image layer 30, 35 is to be replaced.

Each glazing 20, 25 may have a separate sash around the perimeter.

Spacers 70, 72, 75, 77 between the glazing 20, 25 and the light source make up a portion of the sash 90 and set a predetermined distance between the light source sash and the first glazing. Gaskets between the spacers and the glazing and gaskets between the spacers and the light source ensure that the casing 90 is fluid proof. The spacers provide for a preset distance between the first glazing and the illuminable plate face. This space is useful to receive an image layer 30, 35 arranged face to face with the glazing and the illuminable plate face of the light source. The image layer may thus be supported a preset distance away from the illuminable plate face so that bright spots on illuminated plate face are obscured by distance.

The display or decorative fixture in the form of a panel is described here by way of example. FIGS. 2 and 3 show for example the use of spacers. Spacers 70, 72, 75, 77 are optional. A panel without spacers is an equally useful display or decorative fixture. A panel without spacers comprises a solid sandwich without spaces between the light source sheet and the diffusing layer or between the diffusing layer and the image layer, or between the diffusing layer and the window glazing, or between the image layer and the window glazing. Without spacers to separate the sheets, layers, and window glazing they are in contact one against another.

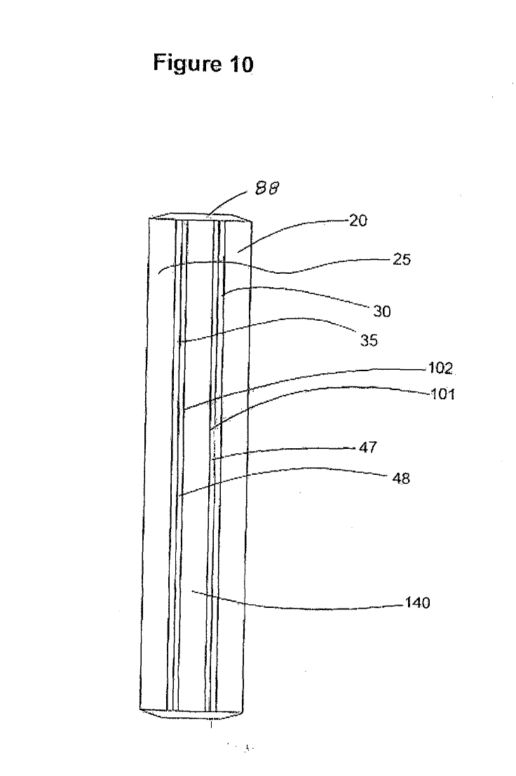

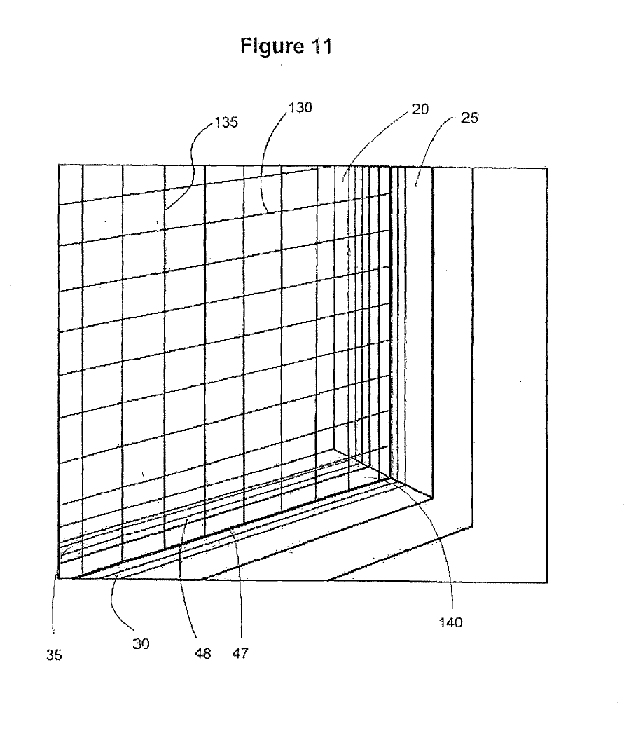

FIGS. 11 and 12 shows the submersible panel where the electroluminescent sheet light source 140, diffusing layer, image layer, and window glazing 20, are all in contact. There is no space between them. As shown in FIG. 10, a layer of sealant 88 is easily swiped around the perimeter to protect the contact layers from ingress of fluid. Because there are no spaces between the layers the panel is relatively thin and does not stand out far from a wall the panel may be mounted against.

As shown in FIG. 1 the first glazing 20 comprises an image. In FIG. 1 the image is a decorative sea-life picture showing artistic fish and seaweed and so forth. The image is visible from the exterior of casing as an image backlit by the light source 100. The decorative fixture in the form of a submersible panel provides an image when submerged.

It is also possible for the second glazing 25 to comprise an image which is decorative and backlit by the light source 100 and visible from the exterior of the submersible panel.

An image layer 30, 35, as shown in the side view of FIG. 3 is placed in the space between the light source 100 and the glazing 20, 25. The image layer 30, 35 is between the illuminable plate face of the light source and the internal face of the glazing. The image of the image layer is visible from the exterior of the glazing as shown in FIG. 1. In FIG. 1 the image layer is a sea-life scene of fish and seaweed backlit by the light source 100. Alternatively or in addition as shown in FIG. 3 an image layer 36 may be fixed by a clip to the exterior of the casing.

The image layer may be removed from and inserted into the interior of the casing of the decorative fixture by passing it through a fluid-proof airlock in a sash 90 of the casing or by removing a glazing from the casing, taking out one image layer from the casing, putting another image layer inside the casing and replacing the glazing.

One use of the display or decorative fixture is as an underwater illumination for a swimming pool or bathtub either built into a wall similar to a tile being inlaid into the wall, or as a divider section of a pool if both sides of the submersible panel are to exhibit illuminated images such as a decorative yet practical divider between deep (for confident swimmers) and shallow (for children) areas of a swimming pool. Not only does the display decorative fixture provide illumination it also provides an image backlit by the light source that can be seen under the surface of the water.

As shown in FIG. 3 the decorative panel is arranged with a first glazing 20 and a second glazing 25 on both sides of the decorative panel. On use of the display or decorative fixture is as a lane divider in a swimming pool. Advantageously swimmers look down into the water while swimming and can see the lane dividers under water.

The first window glazing and or the second window glazing may be arranged to diffuse light that passes through it. The glazing may have an etched surface or frost surface or comprise particles inside it that disperse light passing through the glazing. The illuminable plate face when viewed through the glazing appears to have an evenly distributed radiant light intensity

An alternative arrangement for providing for a diffuse light from the light source is shown in FIG. 7. The faces of the light source are covered with a translucent filter 47, 48. The filter diffuses the light radiated from the light source 100 so that the gridwork lines 130, 135 are not visible and the light source 100 radiates a diffuse light of even intensity across the face of the light source.

Therefore a glazing element is arranged to diffuse light from the light source that passes there through the glazing or the submersible panel comprises diffusing filter covering a face 101, 102 of the light source 100 so as to radiate a diffuse light of even intensity across a face viewable from the exterior of the submersible panel.

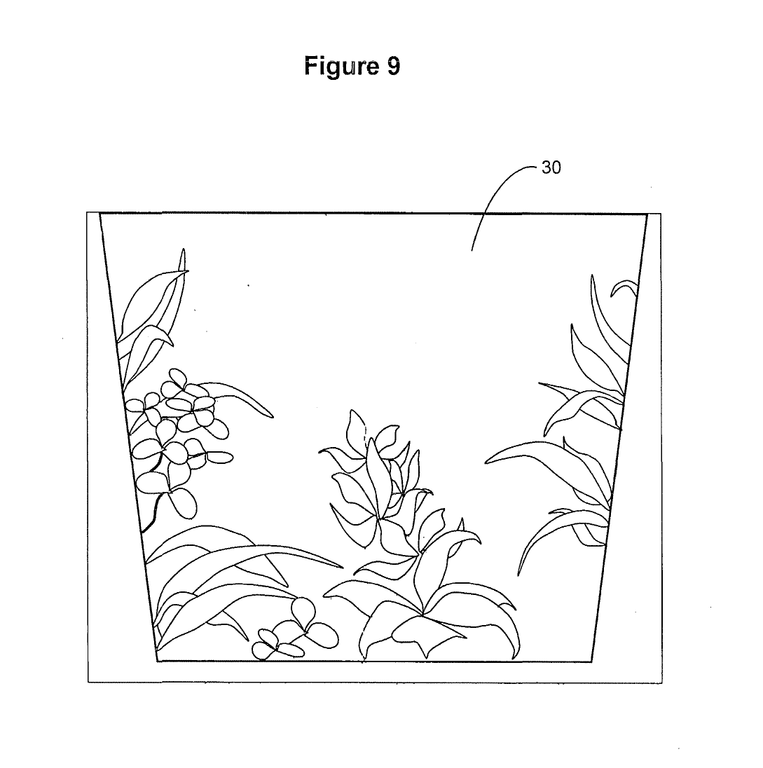

An advantage of an even intensity of light across the face is an even intensity backlight for an image layer 160 as shown in FIG. 9. Because of the filter layer 160, the gridwork is not visible when viewing the image layer 160 from the exterior of the submersible panel and therefore does not distract from the image. The image layer 30, 35 36 in FIG. 9 is fixed in front of the first glazing by a clip.

The second glazing 25 may be arranged to reflect light from the light source 100 back through the first glazing 25 to the exterior of the casing. The second glazing 25 may have a mirrored surface facing the light source 100 so as to reflect light radiated from the light source 100 back through the light source. The first glazing 20 is arranged to pass light from the light source so both light radiated by the light source 100 and light reflected from the second glazing passes through the first glazing 20.

Advantageously the decorative fixture provides more illumination through the first glazing 20 by this arrangement than if the second glazing 25 is not reflective. Alternatively, the backing of the light panel 100 can be opaque white film on the side of glazing 25 which bounces light through the panel 100 rather than it being diffused and then reflected from the glazing 25.

As shown in the side view FIG. 3, there are spacers 120 which separate an illuminable plate face of the light source 100 from the first glazing 20. The spacers set a predetermined distance between the light source 100 and the first glazing 20. There are also separators 120 which separates the opposite face of the light source from the second glazing a predetermined distance. The separation between the face of the light source and the glazing provides space 50 between the glazing 20, 25 and the light source 100.

The interior of the submersible panel is be filled with a dry gas. The casing 20, 25, 90 is fluid-proof so exterior liquid or vapor cannot enter. Condensation inside the casing is prevented because the gas inside the casing is dry. Thus condensation on the internal surface of the window glazings is prevented so as to assure the quality of any backlit image.

The interior of the casing comprises a desiccant.

The sash 90 comprises channels 170 open the interior of the casing. The open ends of the channels are visible in FIG. 2. The channels are filled with a desiccant. The desiccant is a gel or solid which adheres to the walls of the channels. One appropriate desiccant is silica gel which may be injected into the channel.

If the fluid-proof casing has a minor leak to water or water vapor, the desiccant absorbs the water. Condensation on the internal surfaces of the submersible panel 20, 25, 90 or the light source 100 is prevented.

It is possible for the decorative fixture to be constructed without spacers 120. In this arrangement the light source 100 and glazings 20, 25 are in face to face contact. The light source in the form of an illimitable plate with an illuminable plate face that is in direct contact with the glazings 20, 25. The glazings 20, 25 are in the form of window panes so the illuminable plate is sandwiched between the two window panes. By this arrangement no dry gas is needed inside the casing.

The submersible panel comprises an electrical cable passing from the exterior of the casing through the casing and electrically connected to the light source. The cable passage through the case is vapor-proof.

Submerging the decorative panel subjects the glazing 20, 25 to the pressure of the liquid in which the decorative panel is submerged.

The glazing 20, 25 is supported around the perimeter by the sash 90. The pressure of the liquid depresses the glazing into the casing. Thus the external surface of the window glazing 20, 25 is concave. The thickness of the glazing is predetermined so that a predetermined deflection is caused at predetermined depth of submersion. The concave depression of the window glazing surface reduces glare from the external surface of the glazing. Advantageously an observer, who is exterior to the decorative fixture, will observe clearly the image layer 30, 35 inside the casing or an image on the glazing, 20, 25, or an exterior image 36 without reflected glare.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

1. A submersible display comprising:
an electro-luminescent sheet light source that radiates light with a substantially uniform intensity across a substantially planar face area,
a diffusing layer overlaying the face area and
a first window glazing forms an external wall of the display,
the glazing is arranged substantially parallel to and face to face with the sheet light source face area so as to define a sandwich assembly whereby the light source face area is viewable through the glazing.

2. A display according to claim 1 comprises
a fluid proof casing that encases the electro-luminescent sheet light source, and diffusing layer.

3. A display according to claim 2 wherein
the window glazing forms an external wall of the casing.

4. A display according to claim 1 wherein
the diffusing layer is arranged intermediate the electro-luminescent sheet light source face area and the window glazing.

5. (canceled)

6. A display according to claim 1 wherein
the diffusing layer is etched, frosted, baked, or otherwise adhered on the light source face area.

7-8. (canceled)

9. A display according to claim 1 wherein
the window glazing comprises particles inside it that disperse light passing through the window glazing whereby the diffusing layer and the window glazing are an integral sheet.

10. A display according to claim 1 wherein
the light source face area is in contact with the diffusing layer and in turn the diffusing layer is in contact with the first window glazing so as form a sandwich assembly without spaces.

11. A display according to claim 1 wherein
the sheet face is covered by the diffusing layer, an image layer, and the first window glazing
whereby in use light radiates from the light source face area through the image layer to be visible through the first window as a back lit image from the exterior of the casing.

12-14. (canceled)

15. A display according to claim 11 wherein
the image layer and the first window glazing are in the form of a single sheet.

16. (canceled)

17. A display according to claim 11 wherein
the light source face area is in contact with the diffusing layer and in turn the diffusing layer is in contact with the image layer and in turn the image layer is in contact with first window glazing so as to form a sandwich assembly without spaces.

18. A display according to claim 1 wherein
the first window glazing and diffusing layer are arranged to define a space intermediate them, said space dimensioned to receive an image layer face to face with the window glazing and diffusing layer whereby with the image layer in the space light radiates from the light source face area through in turn the diffusing layer, the image layer, and the first window glazing whereby in use the image layer is visible through the first window as a back lit image from the exterior of the casing.

19. A display according to claim 18 further comprising:
a fluid proof air lock in the form of an elongate slot through the casing located parallel and intermediate to the sheet facing and external wall for inserting and removing the image layer into and out of the space.

20. A display according to claim 18 further comprising:
a spacer arranged to set a predetermined distance between the window glazing and diffusing layer.

21-22. (canceled)

23. A display according to claim 11 further comprising:
an image layer support fixed to the casing so as to receive and hold the image layer exterior to the casing face to face with the window glazing whereby in use light radiates from the light source face area through the image layer to be visible as a back lit image from the exterior of the casing.

24. A display according to claim 11 further comprising:
an image layer support arranged to receive and hold the image layer face to face with the window glazing whereby in use light radiates from the light source face area through the image layer to be visible as a back lit image from the exterior of the casing.

25-26. (canceled)

27. A display according to claim 11 wherein,
the image layer, light source, diffusing layer, and first window glazing are transparent providing a transparent view through the display by on-looking through the first window glazing.

28. A display according to claim 1 wherein
the first window glazing is coated with a half-mirror coat whereby light radiated from the planar source face area is visible by on-looking at the first window glazing when the light source is on and a reflective mirror is visible on-looking at the first window glazing when the light source is off.

29. A display according to claim 1 wherein
opposite the light source face area the electro-luminescent sheet light source has a second planar area face area for radiating an even light intensity covered by a second window glazing forming a second external wall of the casing arranged parallel and face to face with the second face area so as to define a sandwich assembly for viewing the face area through the first window glazing and the second face area through the second window glazing.

30-31. (canceled)

32. A display according to claim 29 further comprising
a second image layer covering the second planar face area whereby the second image layer is visible on the opposing side of the submersible panel from which the first image is visible.

33. A display according to claim 1 wherein
the casing comprises a sash to which a window glazing element is sealed.

34-39. (canceled)
